(19) United States
(12) Patent Application Publication
(10) Pub. No.: US 2009/0254866 A1
(43) Pub. Date: Oct. 8, 2009

(54) METHOD AND SYSTEM FOR DISPLAYING A MULTITUDE OF OBJECTS ON A DISPLAY

(76) Inventors: Bernhard Kügle, Mering (DE); Andrea Sari, Freising (DE)

Correspondence Address: STAAS & HALSEY LLP, SUITE 700, 1201 NEW YORK AVENUE, N.W., WASHINGTON, DC, 20005, US

(21) Appl. No.: 12/310,211

(22) PCT Filed: May 14, 2007
(86) PCT No.: PCT/EP2007/054661

§ 371 Date: Feb. 17, 2009

(30) Foreign Application Priority Data
Aug. 16, 2006 (EP) 06017050.3

(51) Int. Cl. G06F 3/048

(52) U.S. Cl. 715/841

(57) ABSTRACT

A method displays a multitude of objects on a display, the display offering an electronic pointer device. A maximum number of objects to be displayed in an adaptable orientation at a time is determined. The multitude of objects are automatically grouped into at least one group containing at most the maximum number of said objects. The groups are listed in a first list. The objects grouped into the group are automatically displayed in a second list upon the electronic pointer device pointing to the group. Furthermore, a display used for the described method is described, as well as a computer system, a maintenance management system and a mobile phone using the described method and display.

### CROSS REFERENCE TO RELATED APPLICATIONS

This application is based on and hereby claims priority to EP Application No. 06017050 filed on Aug. 16, 2006 and PCT Application No. PCT/EP2007/054661 filed on May 14, 2007, the contents of which are hereby incorporated by reference.

### BACKGROUND OF THE INVENTION

The present invention relates to a method and system for displaying a multitude of objects on a display.

In the telecommunication management world, many management systems exist for remote administration of equipment often distributed in a very large territory and in a very large amount of units. Such systems are called OMC (Operation and Maintenance Centre), and their complexity is growing continuously. An OMC provides an operator with a user interface displayed on a display, the user interface offering many graphical facilities to improve system usability. The OMC operator can act at the OMC display as he would act directly at the hardware equipment or interfacing virtual object representing the network management functions.

Considering the increasing of telecommunication network complexity, the number of supervised objects is increasing more and more. As the number of supervised objects increases, there is a necessity to supervise and display a large number of objects at the OMC display.

Although the supervised objects are structured using e.g. groups and levels, it happens that the operator is faced with lists of thousand of objects that cannot be displayed using a single display page due to technical limits.

Currently, such very long lists are displayed using vertical scroll bars, filtering lists to reduce list size, dividing lists into multiple sub-lists or pages, or using more than one monitor. The known methods have many disadvantages. In case of using of scroll bars, the operator can directly access only a part of the list. By using the scroll bar, the focus is moved to another part of the list. The dimension of the displayed part depends on the dimension of the displayed object and the maximal vertical dimension of the monitor used.

In case of using filters, the operator can focus on a specific part of the list, but it is always necessary to perform a new filtering, e.g. insert a new filter condition, in order to display other objects not included in the first list.

In case of using multiple sub-lists or pages, the operator can only access a part of the list. All other list items are present in another sub-list or on another page, and the operator has to turn the page or jump to another sub-list till the desired list item is displayed.

In case of using more than one monitor, the restriction of the monitor dimension is overcome. The display flat can be multiplied using many monitors one upon the other. The operator accesses all the list items moving the mouse pointer over the screen borders. The feasibility of such solution depends on the availability of specific software, together with the needed hardware, making such solution very expensive.

### SUMMARY

It is one potential object to address at the problems discussed above.

The inventors propose provides a method for displaying a multitude of objects on a display, the display offering an electronic pointer device. The method comprises of the following steps:
determining a maximum number of the objects to be displayed in an adaptable orientation at a time
automatically grouping the multitude of objects into at least one group containing at most the maximum number of the objects by selecting a portion of the multitude of objects
displaying the at least one group in a first list
automatically displaying the portion of the multitude of objects grouped into the at least one group in a second list upon the electronic pointer device pointing to the at least one group.

In another embodiment, the portion of the multitude of objects grouped into the at least one group are removed from the display upon the electronic pointer device being moved away from the at least one group.

In another embodiment, the at least one group is automatically assigned a group name based on names of the portion of the multitude of objects grouped into the at least one group.

In another embodiment, the first list and the second list are displayed in a vertical orientation.

Furthermore, the inventors propose a display an electronic pointer device and with a display to display a maximum number of objects in an adaptable orientation at a time, to display at least one group of the objects in a first list, and to automatically display the portion of the multitude of objects grouped into the at least one group in a second list upon the electronic pointer device pointing to the at least one group.

In another embodiment, the display further comprises of an adaptable physical resolution, the adaptable physical resolution limiting the maximum number of the objects to be displayed in an adaptable orientation at a time, and an adapter to adapt the adaptable physical resolution, thereby increasing the maximum number of the objects to be displayed in an adaptable orientation at a time.

Furthermore, the inventors propose a computer system, and a mobile phone, each with at least one display as described above, and with a processor to execute the described method.

Furthermore, the inventors propose a maintenance management system with at least one display as described above, and a maintenance device to maintain a communications system, and with a processor to execute the described method.

Furthermore, the inventors propose a computer readable medium having computer-executable instructions adapted to cause a computer system as described above to perform the described method.

The proposed methods and devices provide the advantage that even very long lists containing a multitude of entries can efficiently be displayed on a limited computer display.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1: shows an automatic grouping process for a list with N entries

FIG. 2: shows the content of a group

FIG. 3: shows a screenshot of a prototypic implementation of the described method

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

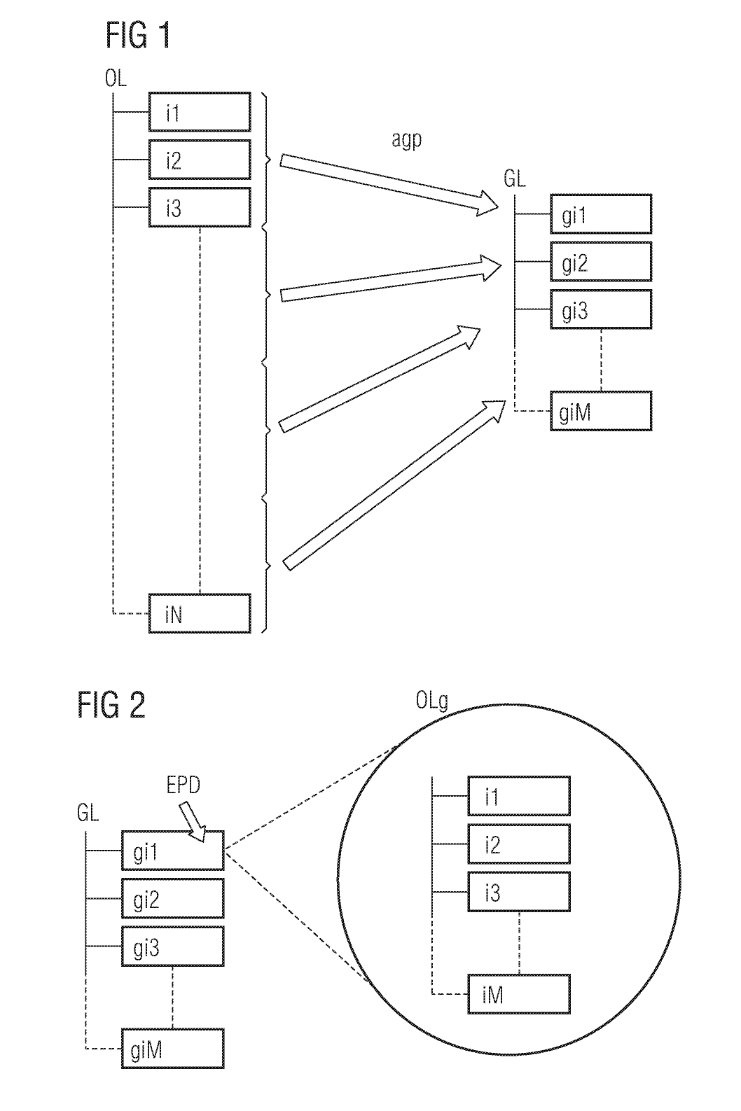

FIG. 1 shows an automatic grouping process agp for a multitude of objects to be displayed on a display, e.g. a computer display. The multitude of objects correspond e.g. to an original list OL with N entries i1, i2, i3, . . . , iN. The display can display a maximum number M of the entries i1, i2, i3, . . . , iN in an adaptable orientation, e.g. in vertical orientation at a time. As the original list OL contains too many entries i1, i2, i3, . . . , iN to be displayed at a time, the automatic grouping process agp selects a first portion i1, i2, i3, . . . , iM of the entries, thereby defining a first group gi1. A second portion of entries selected defines a second group gi2, and so on. Finally, M subgroups are built from the original N list entries i1, i2, i3, . . . , iN. The resulting groups gi1, gi2, gi3, . . . , giM are displayed as a first list GL on the display.

FIG. 2 shows the first portion i1, i2, i3, . . . , iM of the entries grouped into the first group gi1 during the automatic grouping process shown in FIG. 1. The system executing the described method offers an electronic pointer device EPD, e.g. a computer mouse for controlling a mouse pointer. When the mouse pointer EPD is moved to a group displayed gi1, gi2, gi3, . . . , giM in the first list GL, automatically the content of this group is displayed, e.g. in a subgroup space, on the display. By this, the entries i1, i2, i3, . . . , iM of the original list OL are displayed and accessible. This effect of automatically displaying the content of a group gi1, gi2, gi3, . . . , giM in case of moving the mouse pointer EPD to the group gi1, gi2, gi3, . . . , giM may be seen as a loupe effect for very long lists, thereby allowing a fast and easy access to each single entry of the original list OL.

In the following, the method is described using an example.

In this example, the original list OL contains 2000 entries i1, i2, i3, . . . , iN. These entries i1, i2, i3, . . . , iN represent e.g. cells of a mobile communications network. Each entry i1, i2, i3, . . . , iN requires 4 mm of vertical space when displayed on a display. The display in this embodiment has a vertical screen dimension of 290 mm. Consequently, on the display a maximum M of 72 entries i1, i2, i3, . . . , iN can be displayed at a time. As there are 2000 entries i1, i2, i3, . . . , iN to be displayed, the method can automatic build 72 groups gi1, gi2, gi3, . . . , giM, each of these groups gi1, gi2, gi3, . . . , giM having 27 or 28 entries i1, i2, i3, . . . , iN:
2000:72=27 Rest 56

In this case, moving the mouse pointer EPD to one of the 72 groups gi1, gi2, gi3, giM, displayed in the first list GL, the display shows the 27 or 28 entries i1, i2, i3, . . . , iM of the original list OL. The content of the group gi1, gi2, gi3, . . . , giM can for example be displayed in a pop up window, forming a group space on the display.

The maximal performance of the presented method can be considered as 72 groups, each containing 72 grouped entries i1, i2, i3, . . . , iM taken form the original list OL, thereby allowing 5184 list entries i1, i2, i3, . . . , iN to be displayed on the display without scrolling or turning to another display page.

The above described example can be considered as a gross calculation as normally the space available at a computer display is less than the maximal vertical screen dimension. Nevertheless, even with a smaller available vertical space the presented method for the automatic grouping process permits to display some thousands of objects at a time without scrolling or turning the page.

As it is necessary to assign a name to each displayed object on the computer display, and as only the original list OL entries i1, i2, i3, . . . , iN have a real name assigned, for the groups gi1, gi2, gi3, . . . , giM created “artificially” by the method new “artificial” names must be assigned. In the following is described how names can be assigned.

The normal case is to assign an unambiguous name to each object by using an integer value. The “artificial” name for a group gi1, gi2, gi3, . . . , giM is accordingly constructed with respect to the name range of the contained objects i1, i2, i3, . . . , iM.

For example, considering cells with corresponding cell IDs, the original list items i1, i2, i3, . . . , iN have the following names:
cellId=1, cellId=2, cellId=5, . . . , cellId=5184

In case of the above example with groups gi1, gi2, gi3, . . . , giM containing 72 objects, the groups gi1, gi2, gi3, . . . , giM get the following “artificial” names:
cellGroupId=cells1to72,
cellGroupId=cells73to144, . . .
cellGroupId=cells5112to5184

Naming groups in the above manner enables the operator to easily find an object based on the original list item name.

Alternatively, the automatic grouping process can follow an alphabetical principle. In fact, although in the example above the cellId is taken as reference, the described method works with all alphanumeric characters (digits and letters) as long as the operator recognizes the original name when looking at the subgroup name.

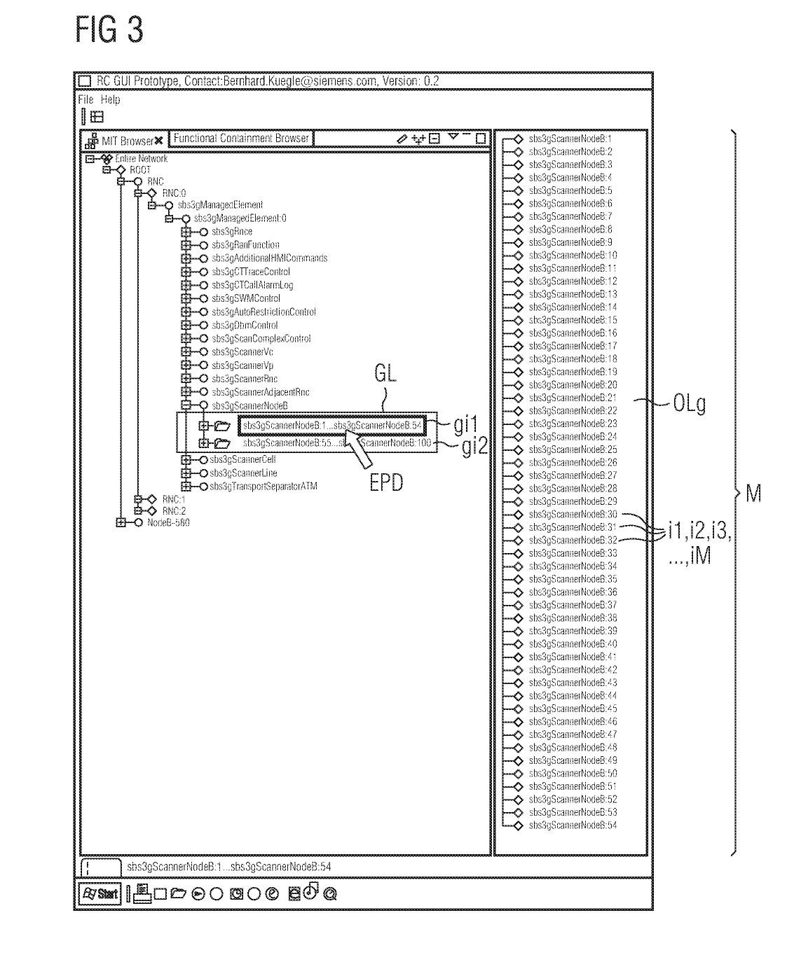

FIG. 3 shows a screenshot of a prototypic implementation of the described method. The screenshot shows a windows containing the first list GL with groups gi1, gi2 defined by the above described method. The names for the groups gi1, gi2 are defined based on the names of the original list items i1, i2, i3, . . . , iM shown in the second list OLg. The original list items i1, i2, i3, . . . , iM are named by a fixed string concatenated with an integer representing a unique id, in the example ids from the range from 1 to 100. Each defined group gi1, gi2 contains 54 entries i1, i2, i3, . . . , iM, as this is the maximum number M of the entries i1, i2, i3, . . . , iN to be displayed in a vertical manner at a time on the used computer display. Therefore, the first group gi1 is named “sbs3gScannerNodeB:1 . . . sbs3gScannerNodeB:54”, and the second group gi2 is named “sbs3gScannerNodeB:55 . . . sbs3gScannerNodeB:100”, thereby showing to an operator that the first group gi1 contains the original list entries i1, i2, i3, . . . , iM with ids 1 to 54, while the second group gi2 contains the original list entries i1, i2, i3, . . . , iM with ids 55 to 100. In the example, the mouse pointer EPD is moved to the first group gi1, therefore automatically the content of the first group gi1, i.e. the original list entries i1, i2, i3, . . . , iM with ids 1 to 54 is displayed in the second list OLg using a group space on the display, i.e. a certain part of the window or a new window.

In another embodiment, the described method is executed recursively i.e., after a first execution, the automatic grouping is executed at least a second time in at least a second execution, with the automatically defined groups gi1, gi2, gi3, . . . , giM resulting from the first execution being automatically grouped into subgroups in the at least second execution. The recursive application of the described method terminates when the number of defined subgroups during a recursive execution no longer exceeds the maximum number M of the objects i1, i2, i3, . . . , iN, gi1, gi2, gi3, . . . , giM to be displayed.

The described method for displaying very long lists on a computer display has many advantages.

In the case of system monitoring, e.g. monitoring mobile communications systems, in order to perform a systematic surveillance of the managed objects represented by the list items, it is necessary to have all the objects on the screen at a time. As soon as an object gets a remarkable status for the operator, the graphical representation changes in an opportune way (e.g. blinking, changing the dimension or colour and so on). The described methods ensure that the general view of all the managed objects is not lost.

The described method is furthermore advantageous with respect to operator reaction time. Due to an abnormal system situation (e.g. alarm by a managed object) it is very important from the operator's point of view to be provided with a quick and easy access to the affected object to react in a proper way, e.g. lock the object or perform a diagnostic test. Having all the objects on the screen at a time, it is not necessary to search for the affected object by browsing through many pages or scrolling the list up and down. The described method allows to immediately locating the affected object on the screen without any mouse click.

The described method improves system usability in a significant way, reducing the reaction time at the operator level.

As the described automatic grouping process takes place automatically in a way that the operator always gets all the objects grouped in the most suitable manner, the necessity of time-consuming extra actions like scrolling or turning a page are effectively avoided.

To summarize, by applying the described automatic grouping process of objects and a sort of zoom it is possible to go through a very long list of objects without using e.g. scroll bars, thereby maintaining all the supervised objects in the same display page at a time.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-10. (canceled)

11. A method for displaying a plurality of objects on a display, the display having an electronic pointer device, comprising:
determining a maximum number of the objects to be displayed in an adaptable orientation at one time;
automatically grouping the plurality of objects into a plurality of groups each containing at most the maximum number of objects, each group being formed by automatically selecting a portion of the plurality of objects;
displaying a list of the groups in a first list; and
automatically displaying the objects grouped into a first of the groups in a second list when the electronic pointer device points to the first group in the first list.

12. The method in claim 11, wherein the objects of the first group are removed from the display upon the electronic pointer device being moved away from the first group in the first list.

13. The method as claimed in claim 11, wherein each group is automatically assigned a group name based on names of the objects assigned to the group.

14. The method as claimed claim 11, wherein the first list and the second list are displayed in a vertical orientation.

15. The method as claimed in claim 12, wherein each group is automatically assigned a group name based on names of the objects assigned to the group.

16. The method as claimed claim 15, wherein the first list and the second list are displayed in a vertical orientation.

17. A display device, comprising:
a display screen to display at most a maximum number of objects in an adaptable orientation at one time, the display screen having a first display area to display a list of groups of objects in a first list; and
an electronic pointer device to select a first group from the first list, the display screen having a second display field to automatically display the objects of the first group in a second list upon the electronic pointer device pointing to the first group in the first list.

18. The display device according to claim 15, further comprising:
an adaptable physical resolution setting device to adapt a physical resolution of the display device, the physical resolution limiting the maximum number of objects that can be displayed in an adaptable orientation at one time; and
a list adapter to adapt the physical resolution, thereby increasing the maximum number of objects that can be displayed at one time.

19. A computer system, comprising:
a display screen to display at most a maximum number of objects in an adaptable orientation at one time, the display screen having a first display area to display a list of groups of objects in a first list;
an electronic pointer device to select a first group from the first list, the display screen having a second display field to automatically display the objects of the first group in a second list upon the electronic pointer device pointing to the first group in the first list; and
means for executing the method of claim 11.

20. A maintenance management system, comprising:
a display screen to display at most a maximum number of objects in an adaptable orientation at one time, the display screen having a first display area to display a list of groups of objects in a first list;
an electronic pointer device to select a first group from the first list, the display screen having a second display field to automatically display the objects of the first group in a second list upon the electronic pointer device pointing to the first group in the first list;
means for maintaining a communications system; and
means for executing the method of claim 11.

21. A mobile phone comprising:
a transceiver device;
a display screen to display at most a maximum number of objects in an adaptable orientation at one time, the display screen having a first display area to display a list of groups of objects in a first list;
an electronic pointer device to select a first group from the first list, the display screen having a second display field to automatically display the objects of the first group in a second list upon the electronic pointer device pointing to the first group in the first list; and
means for executing the method of claim 11.

22. A computer readable storage medium storing a computer program to cause a computer system to perform the method of claim 11.
